(19) United States
(12) Patent Application Publication
(10) Pub. No.: US 2026/0064591 A1
(43) Pub. Date: Mar. 5, 2026

(54) DATA ERASE USING A MAPPING TABLE UPDATE IN A HOST DEVICE WITH FLASH MEMORY SYSTEM

(71) Applicant: QUALCOMM Incorporated, San Diego, CA (US)

(72) Inventors: Santhosh Reddy Akavaram, Hyderabad (IN); Chintalapati Bharath Sai Varma, Hyderabad (IN); Madhu Yashwanth Boenapalli, Hyderabad (IN)

(21) Appl. No.: 18/821,327

(22) Filed: Aug. 30, 2024

(51) Int. Cl. G06F 12/02; G06F 13/16

(52) U.S. Cl. CPC G06F 12/0292; G06F 12/0246; G06F 13/1668

(57) ABSTRACT

This disclosure provides systems, methods, and devices for memory systems that support erasing data in a memory device using an update on a mapping table in a host device. In a first aspect, a method of erasing data in a flash memory system includes a host memory controller receiving a request to erase data on a memory device; and transmitting an update on a mapping table in the host device to the memory device, the update on the mapping table being associated with the data. Other aspects and features are also claimed and described.

### TECHNICAL FIELD

Aspects of the present disclosure relate generally to an apparatus and method for controlling a memory device. Some aspects may, more particularly, relate to an apparatus and method for controlling operations for erasing data in a memory device using an update on a mapping table in a host device.

### INTRODUCTION

As the value and use of information continues to increase, individuals and businesses seek additional ways to process and store information. In addition, the use of information in various locations and desired portability of information is increasing. For this reason, users are increasingly turning towards the use of portable electronic devices, such as mobile phones, digital cameras, laptop computers and the like. Portable electronic devices generally employ a memory system using a memory device for storing data. A memory system may be used as a main memory or an auxiliary memory of a portable electronic device.

The memory device of the memory system may include one kind or a combination of kinds of storage. For example, magnetic-based memory systems, such as hard disk drives (HDDs), store data by encoding data as a combination of small magnets. As another example, optical-based memory systems, such as digital versatile discs (DVDs) and Blu-ray media, store data by encoding data as physical bits that cause different reflections when illuminated by a light source. As a further example, electronic memory devices store data as collections of electrons that can be detected through voltage and/or current measurements.

Electronic memory devices can be advantageous in certain systems in that they may access data quickly and consume a small amount of power. Examples of an electronic memory device having these advantages include universal serial bus (USB) memory devices (sometimes referred to as “memory sticks”), a memory card (such as used in some cameras and gaming systems), and solid state drive (SSDs) (such as used in laptop computers). NAND flash memory is one kind of memory device that may be used in electronic memory devices. NAND flash memory is manufactured into memory cards or flash disks. Example memory cards include compact flash (CF) cards, multimedia cards (eMMCs), smart media (SM) cards, and secure digital (SD) cards.

A memory system may, in some cases, be integrated with or otherwise connected to a host device, such as an electronic device. For example, memory systems may be integrated with host devices in a system on chip (SoC). As one particular example, a flash memory system, which may be a universal flash storage (UFS) memory system, may be integrated into an electronic device, such as an access point (AP), station (STA), user equipment (UE), base station, modem, camera, automobile, or other system.

One standard for organization and operation of electronic memory devices is the Universal Flash Storage (UFS) standard. The UFS standard was introduced as a successor to the eMMC (embedded MultiMediaCard) standard to offer higher performance and lower power consumption for mobile and other embedded devices. UFS provides support for a range of features such as multi-lane configurations, command queuing, and power-saving modes that enable high-speed data transfer rates, low latency, and long battery life. The UFS standard specifies many parameters for structuring, reading data from, and writing data to UFS-compliant memory devices. For example, UFS-compliant devices may include digital cameras, mobile phones, consumer electronic devices, and other devices with internal memory capacity. UFS-compliant memory may include memory embedded within electronic devices and removable memory cards, and UFS memory devices may implement NAND flash memory.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure provides systems, apparatus, methods, and computer-readable media that support data processing, including techniques for erasing data in the memory device using an updated mapping table in the host device. For example, when a host device attempts to erase data in a memory device electrically coupled to the host system, the host device may efficiently utilize the bus bandwidth (e.g., universal flash storage (UFS) bus bandwidth) by reducing the number of communications on the bus to transmit to and receive from the memory device. The host device may invalidate logical block address (LBA) entries at the host device and share the invalidated regions with the memory device by embedding the invalidated region information in a command (e.g., Command UFS Protocol Information Unit (UPIU)) or using a write command (a Host Performance Booster (HPB) write command) for the invalidated regions. In some scenarios, the host device may receive a request to erase data on the memory device and update a logical to physical (L2P) mapping table stored in the host device. The L2P mapping table may include an invalidated logical block address, which was associated with the data but is mapped to a physical address having zero. Then, the host device may transmit the update of the L2P mapping table to the memory device using the command (e.g., the Command UPIU or the HPB write command). Then, the memory device may update a memory device L2P table based on the update transmitted from the host device and transmit a response including the status of the memory device L2P table update.

Particular implementations of the subject matter described in this disclosure may be implemented to realize one or more of the following potential advantages or benefits. In some aspects, the present disclosure provides techniques for improved performance of a memory system. For example, the techniques in the present disclosure reduce power consumption and input/output latencies due to efficient utilization of the UFS bus bandwidth when the memory device erases data. In addition, due to reduced bus traffic, the memory device can easily and promptly enter hibernate mode to save the power consumption.

In an additional aspect of the disclosure, an apparatus includes a memory controller of a host device configured to couple the host device to a memory system through a first interface, the memory controller configured to perform operations including receiving, by the memory controller of the host device, a request to erase data on the memory device; and transmitting, by the memory controller of the host device, an update on a mapping table in the host device, the update on the mapping table being associated with the data. In another aspect of the disclosure, a method for performing these operations by a processor by executing instructions stored in a memory coupled to the processor is also disclosed. In an additional aspect of the disclosure, a non-transitory computer-readable medium stores instructions that, when executed by a processor, cause the processor to perform these operations.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a data processing system including a memory system in accordance with an embodiment of the present invention.

FIG. 2 is a block diagram illustrating an example electronic device including the memory system according to one or more aspects of the disclosure.

FIG. 3 is a block diagram illustrating components for facilitating access to a flash memory device from a host device according to some embodiments of the disclosure.

FIG. 4 is a block diagram illustrating a method for erasing data in a memory device using an update on a mapping table in a host device according to some embodiments of the disclosure.

FIG. 5 is a call diagram illustrating a method for erasing data in a memory device using an update on a mapping table in a host device according to some embodiments of the disclosure.

FIG. 6 is a flow chart illustrating a method for erasing data in a memory device using an update on a mapping table in a host device according to some embodiments of the disclosure.

FIG. 7 is a flow chart illustrating a method for erasing data in a memory device using an update on a mapping table in a host device according to some embodiments of the disclosure.

FIG. 8 is a block diagram illustrating details of an example wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In the current standard (e.g., Universal Flash Storage (UFS) 4.0 Specification), erase operations include numerous messages between the host device and the memory device, which increases power consumption and increases latency, both of which are undesirable in a memory system. Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

The present disclosure provides systems, apparatus, methods, and computer-readable media that support data processing, including techniques for erasing data in the memory device using an updated mapping table in the host device. For example, when a host device erases data in a memory device electrically coupled to the host system, the host device may efficiently utilize the bus bandwidth (e.g., UFS bus bandwidth) by reducing the number of communications on the bus to transmit to and receive from the memory device. The host device may invalidate Logical Block Address (LBA) entries at the host device and share the invalidated regions with the memory device by embedding the invalidated region information in a command (e.g., Command UFS Protocol Information Unit (UPIU)) or using a write command (a Host Performance Booster (HPB) write command) for the invalidated regions. In some scenarios, the host device may receive a request to erase data on the memory device and update a logical to physical (L2P) mapping table stored in the host device. The L2P mapping table may include an invalidated logical block address, which was associated with the data but is mapped to a physical address having zero. Then, the host device may transmit the update of the L2P mapping table to the memory device using the command (e.g., the Command UPIU or the HPB write command). Then, the memory device may update a memory device L2P table based on the update transmitted from the host device and transmit a response including the status of the memory device L2P table update.

Particular implementations of the subject matter described in this disclosure may be implemented to realize one or more of the following potential advantages or benefits. In some aspects, the present disclosure provides techniques for improved performance of a memory system. For example, the techniques in the present disclosure reduce power consumption and input/output latencies due to efficient utilization of the UFS bus bandwidth when the memory device erases data. In addition, due to reduced bus traffic, the memory device can easily and promptly enter hibernate mode to save the power consumption.

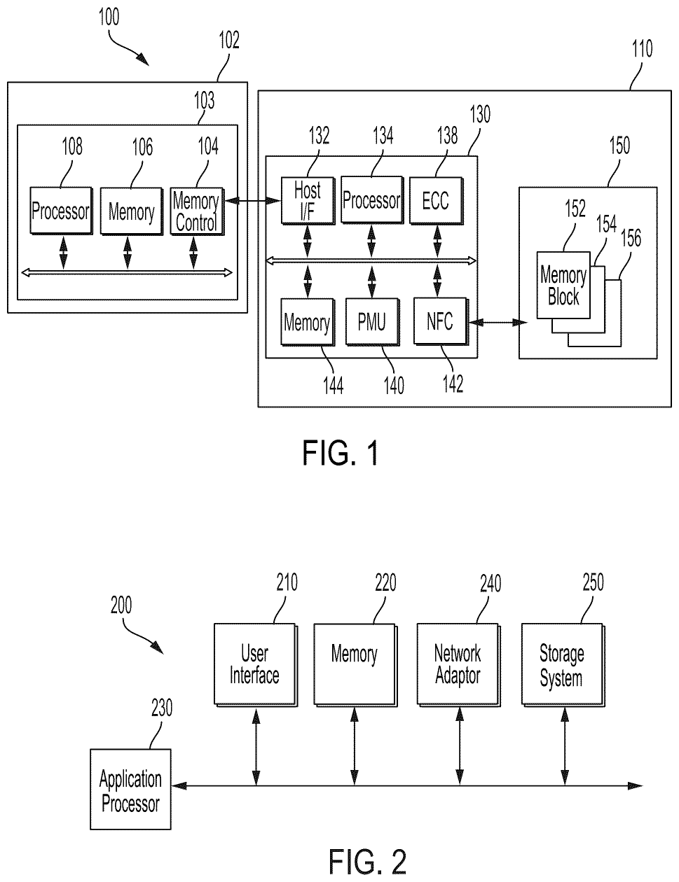

Memory may be used in a computing system organized as illustrated in FIG. 1. FIG. 1 illustrates a data processing system 100, such as may be included in a mobile computing device, according to one or more aspects of the disclosure. A memory system 110 may couple to a host device 102 through one or more channels. For example, the host device 102 and memory system 110 may be coupled through a serial interface including a single channel for the transport of data or a parallel interface including two or more channels for the transport of data. In some aspects, control data may be transferred through the same channel(s) as the data or the control data may be transferred through additional channels.

The host device 102 may be, for example, a portable electronic device such as a mobile phone, an MP3 player, a laptop computer, or a non-portable electronic device such as a desktop computer, a game player, a television (TV), a media player, or a projector. As another example, the host device 102 may be an automotive computer system. The host device 102 may include a system on chip (SoC) 103 that includes a memory controller 104 to manage memory system power, a memory 106, and a processor 108.

The memory controller 104 may mange power states of the memory system 110 and transmit commands to the memory system 110, and may communicate with the memory system 110. The memory controller 104 may communicate with another system (e.g., a user input device, an external system, or an internal system of the data processing system or the user device 100) to receive an input or a command. The communication is made through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). For example, the host interface 132 may be a parallel interface such as an MMC interface, or a serial interface such as an ultra-high speed class 1 (UHS-I)/UHS class 2 (UHS-II) or a universal flash storage (UFS) interface.

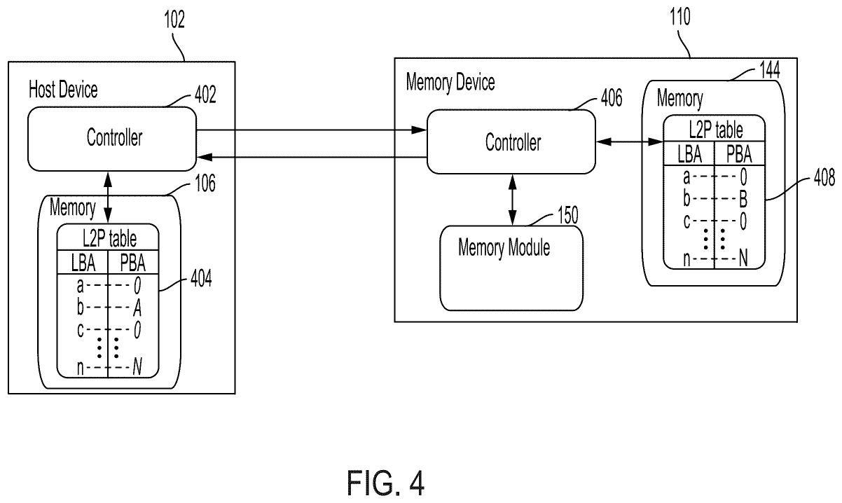

The memory 106 may serve as a working memory of the host device 102. The memory 106 may store host software to manage memory system power. Also, the memory may store instructions (e.g., steps in FIG. 4) for the processor 108 to perform. The memory 106 may be implemented with a volatile memory such as, for example, a static random access memory (SRAM) or a dynamic random access memory (DRAM). In some aspects, the memory 106 may store a mapping table, address mappings, a program memory, a data memory, a write buffer, a read buffer, a map buffer, and the like.

The processor 108 may control the general operations of the host device 102, manage power states, and transmit a write request or a read request to the memory system 110. For example, the processor 108 using the instructions or software in the memory 106 to determine the maximum power that may be allocated to the memory system 110 and set a power state to an operation that consumes the amount of power or less. In some examples, the processor may modify the power state to best satisfy changing power and performance objectives. The example power states and their maximum powers are listed in Table 1. The processor may execute firmware, which may be referred to as a flash translation layer (FTL), to control the general operations of the host device 102. The processor 108 may be implemented, for example, with a microprocessor or a central processing unit (CPU), or an application-specific integrated circuit (ASIC).

In some examples, the memory system 110 may be included in the host device 102. Thus, the data processing system or user device 100 may be any of the example host devices described herein including the memory system 110.

The memory system 110 may execute operations in response to commands (e.g., a request) from the host device 102. For example, the memory system 110 may store data provided by the host device 102 and the memory system 110 may also provide stored data to the host device 102. The memory system 110 may be used as a main memory, short-term memory, or long-term memory by the host device 102. As one example of main memory, the host device 102 may use the memory system 110 to supplement or replace a system memory by using the memory system 110 to store temporary data such as data relating to operating systems and/or threads executing in the operation system. As one example of short-term memory, the host device 102 may use the memory system 110 to store a page file for an operating system. As one example of long-term memory, the host device 102 may use the memory system 110 to store user files (e.g., documents, videos, pictures) and/or application files (e.g., word processing executable, gaming application).

The memory system 110 may be implemented with any one of various storage devices, according to the protocol of a host interface for the one or more channels coupling the memory system 110 to the host device 102. The memory system 110 may be implemented with any one of various storage devices, such as a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The memory system 110 may include a memory module 150 and a system controller 130 coupled to the memory module 150 through one or more channels. The memory module 150 may store and retrieve data in memory blocks 152, 154, and 156 under control of the system controller 130, which may execute commands received from the host device 102. The system controller 130 is configured to control data exchange between the memory module 150 and the host device 102. The storage components, such as blocks 152, 154, and 156 in the memory module 150 may be implemented as volatile memory device, such as, a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a NAND flash memory.

The system controller 130 and the memory module 150 may be formed as integrated circuits on one or more semiconductor dies (or other substrate). In some aspects, the system controller 130 and the memory module 150 may be integrated into one chip. In some aspects, the memory module 150 may include one or more chips coupled in series or parallel with each other and coupled to the system controller 130, which is on a separate chip. In some aspects, the memory module 150 and system controller 130 chips are integrated in a single package, such as in a package on package (PoP) system. In some aspects, the memory system 110 is integrated on a single chip with one or more or all of the components (e.g., application processor, system memory, digital signal processor, modem, graphics processor unit, memory interface, input/output interface, network adaptor) of the host device 102, such as in a system on chip (SoC). The system controller 130 and the memory module 150 may be integrated into one semiconductor device to form a memory card, such as, for example, a Personal Computer Memory Card International Association (PCMCIA) card, a compact flash (CF) card, a smart media card (SMC), a memory stick, a multimedia card (MMC), an RS-MMC, a micro-MMC, a secure digital (SD) card, a mini-SD, a micro-SD, an SDHC, and a universal flash storage (UFS) device.

The system controller 130 of the memory system 110 may control the memory module 150 in response to commands from the host device 102. The system controller 130 may execute read commands to provide the data from the memory module 150 to the host device 102. The system controller 130 may execute write commands to store data provided from the host device 102 into the memory module 150. The system controller 130 may execute other commands to manage data in the memory module 150, such as program and erase commands. The system controller 130 may also execute other commands to manage control of the memory system 110, such as setting configuration registers of the memory system 110. By executing commands in accordance with the configuration specified in the configuration registers, the system controller 130 may control operations of the memory module 150, such as read, write, program, and erase operations.

The system controller 130 may include several components configured for performing the received commands. For example, the system controller 130 may include a host interface (I/F) unit 132, a processor 134, an error correction code (ECC) unit 138, a power management unit (PMU) 140, a NAND flash controller (NFC) 142, and/or a memory 144. The power management unit (PMU) 140 may provide and manage power for components within the system controller 130 and/or the memory module 150.

The host interface unit 132 may process commands and data provided from the host device 102, and may communicate with the host device 102. The host interface unit 132 can be similar to the memory controller 104. For example, the host interface unit 132 may process commands and data provided from the host device 102, and may communicate with the host device 102, through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). For example, the host interface 132 may be a parallel interface such as an MMC interface, or a serial interface such as an ultra-high speed class 1 (UHS-I)/UHS class 2 (UHS-II) or a universal flash storage (UFS) interface.

The ECC unit 138 may detect and correct errors in the data read from the memory module 150 during the read operation. The ECC unit 138 may not correct error bits when the number of the error bits is greater than a threshold number of correctable error bits, which may result in the ECC unit 138 outputting an error correction fail signal indicating failure in correcting the error bits. In some aspects, no ECC unit 138 may be provided or the ECC unit 138 may be configurable to be active for some or all of the memory module 150. The ECC unit 138 may perform an error correction operation using a coded modulation such as a low-density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), or a Block coded modulation (BCM).

The NFC 142 provides an interface between the system controller 130 and the memory module 150 to allow the system controller 130 to control the memory module 150 in response to a command received from the host device 102. The NFC 142 may generate control signals for the memory module 150, such as signals for rowlines and bitlines, and process data under the control of the processor 134. Although NFC 142 is described as a NAND flash controller, other controllers may perform similar function for other memory types used as memory module 150.

The memory 144 may serve as a working memory of the memory system 110 and the system controller 130. The memory 144 may store data for driving the memory system 110 and the system controller 130. When the system controller 130 controls an operation of the memory module 150 such as, for example, a read, write, program or erase operation, the memory 144 may store data which are used by the system controller 130 and the memory module 150 for the operation. The memory 144 may be implemented similar to the memory 106 of the host device 102. For example, the memory 144 may be implemented with a volatile memory such as, for example, a static random access memory (SRAM) or a dynamic random access memory (DRAM). In some aspects, the memory 144 may store address mappings, a program memory, a data memory, a write buffer, a read buffer, a map buffer, and the like.

The processor 134 may control the general operations of the memory system 110, and a write operation or a read operation for the memory module 150, in response to a write request or a read request received from the host device 102, respectively. For example, the processor 134 may execute firmware, which may be referred to as a flash translation layer (FTL), to control the general operations of the memory system 110. The processor 134 may be implemented similar to the processor 108 of the host device 102. For example, the processor 134 may be implemented, for example, with a microprocessor or a central processing unit (CPU), or an application-specific integrated circuit (ASIC).

FIG. 2 is a block diagram illustrating an example electronic device including the data processing system or user device 100 according to one or more aspects of the disclosure. The electronic device 200 may include a user interface 210, a memory 220, an application processor 230, a network adaptor 240, and a storage system 250 (which may be one embodiment of the data processing system or user device 100 of FIG. 1). The application processor 230 may be coupled to the other components through a bus, such as a peripheral component interface (PCI) bus, including a PCI express (PCIe) bus.

The application processor 230 may execute computer program code, including applications, drivers, and operating systems, to coordinate performing of tasks by components included in the electronic device 200. For example, the application processor 230 may execute a storage driver for accessing the storage system 250. The application processor 230 may be part of a system-on-chip (SoC) that includes one or more other components shown in electronic device 200. In some examples, the application processor 230 may correspond to the processor 108 in the host device 102.

The memory 220 may operate as a main memory, a working memory, a buffer memory or a cache memory of the electronic device 200. The memory 220 may include a volatile random access memory such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDRAM, an LPDDR2 SDRAM, an LPDDR3 SDRAM, an LPDDR4 SDRAM, an LPDDR5 SDRAM, or an LPDDR6 SDRAM, or a nonvolatile random access memory such as a phase change random access memory (PRAM), a resistive random access memory (ReRAM), a magnetic random access memory (MRAM) and a ferroelectric random access memory (FRAM). In some aspects, the application processor 230 and the memory 220 may be combined using a package-on-package (POP). In some examples, the memory 220 may correspond to the memory 106 in the host device 102.

The network adaptor 240 may communicate with external devices. For example, the network adaptor 240 may support wired communications and/or various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (Wi-Di), and so on, and may thereby communicate with wired and/or wireless electronic appliances, for example, a mobile electronic appliance.

The storage system 250 may store data, for example, data received from the application processor 230, and transmit data stored therein, to the application processor 230. The storage system 250 may be a non-volatile semiconductor memory device, such as a phase-change RAM (PRAM), a magnetic RAM (MRAM), a resistive RAM (ReRAM), a NAND flash memory, a NOR flash memory, or a 3-dimensional (3-D) NAND flash memory. The storage system 250 may be a removable storage medium, such as a memory card or an external drive. For example, the storage system 250 may correspond to the user device 100, the host device 102, and/or the memory system 110 described above with reference to FIG. 1 and may be a SSD, eMMC, UFS, or other flash memory system.

The user interface 210 provide one or more graphical user interfaces (GUIs) for inputting data or commands to the application processor 230 or for outputting data to an external device. For example, the user interface 210 may include user input interfaces, such as a virtual keyboard, a touch screen, a camera, a microphone, a gyroscope sensor, or a vibration sensor, and user output interfaces, such as a liquid crystal display (LCD), an organic light emitting diode (OLED) display device, an active matrix OLED (AMOLED) display device, a light emitting diode (LED), a speaker, or a haptic motor. The operations and capabilities described above may be used for a memory system that supports improved power state transition and management.

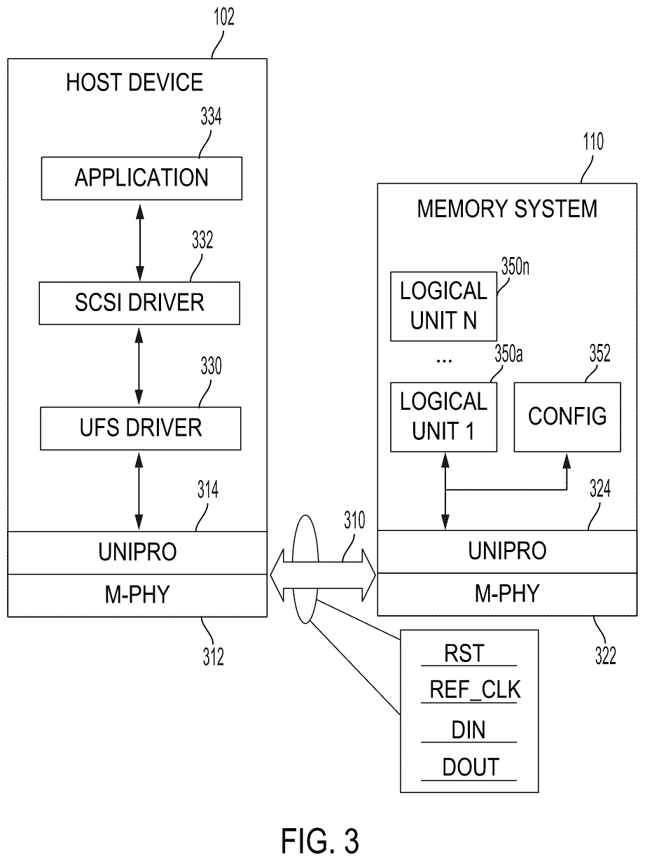

FIG. 3 is a block diagram illustrating components for facilitating access to a flash memory system from a host device according to some embodiments of the disclosure. The host device 102 accesses the memory system 110 through a first interface 310. The first interface may, for example, be a memory interface such as a physical interface (PHY) connecting the host device 102 to the memory system 110. The host device 102 may include physical layer access block 312, which is configured to generate signals for output to the memory interface 310 and process signals received through the memory interface 310. The memory system 110 includes a similarly configured physical layer access block 322 for communicating on the memory interface 310. One example physical layer specification for communicating on the memory interface 310 is the MIPI M-PHY™ physical layer specification.

The host device 102 also includes a data link layer block 314 configured to format frames of data for transmission on the memory interface 310. The frames may be provided to the physical layer access block 312 for transmission. The data link layer block 314 may receive frames from the physical layer access block 312 and decode frames of data received on the memory interface 310. The memory system 110 includes a similarly configured data link layer block 324 for processing frames transmitted on or received on the memory interface 310 by the physical layer access block 322. One example data link protocol for communicating on a MIPI M-PHY™ physical link is the MIPI UNIPRO™ specification.

The memory system 110 includes N logical units 350a-n comprising logical memory blocks for storing information including user data (e.g., user documents, application data) and configuration data (e.g., information regarding operation of the memory system 110). The logical units 350a-n may map to portions of the physical memory blocks 152, 154, and 156. Some of the logical units 350a-n or portions of the logical units 350a-n may be configured with write protection, with boot capability, as a specific memory type (e.g., default, system code, non-persistent, enhanced), with priority access, or with replay protection as a replay protected memory block (RPMB). The physical layer access block 322 and the data link layer block 324 perform operations of a memory controller for the memory system 110 for storing and retrieving data in logical units 350a-n.

The memory system 110 may store a memory device mapping table (e.g., a logical to physical (L2P) table) mapping the logical units 350a-n to physical memory blocks 152, 154, and 156. For example, a mapping table may include one or more entries with each entry identifying a logical unit (e.g., by a logical address) and a corresponding physical memory block (e.g., by a physical address) to which the logical unit is mapped. The host device 102 may request mapping information regarding the contents of the mapping table stored by the memory system 110 and may use such information to request information stored in the logical units 350a-n. In some cases, such as when a host device and/or memory system or device are configured to erase data in the memory device, a corresponding mapping table may be stored in a memory of the host device 102 to allow the host device 102 more rapid access to the mapping table.

The memory system 110 also includes configuration structures 352. The configuration structures 352 may include information such as configuration descriptors for boot enable (bBootEnable), initial power mode (bInitPowerMode), RPMB active (bRPMBRegionEnable), and/or RPMB region (bRPMBRegion1Size, bRPMBRegion2Size, bRPMBRegion3Size). Such configuration structures and/or parameters may, for example, be configuration structures and/or parameters identified by the UFS standard.

The host device 102 may be configured to execute one or more applications 334, such as user applications executed by an operating system under the control of a user to receive user input and provide information stored in the memory system 110 to the user. The host device 102 may include several components for interfacing the application 334 to the memory system 110 through the memory interface 310. For example, a SCSI driver 332 and a UFS driver 330 may interface the application 334 to a host memory controller that includes the data link layer block 314 and the physical layer access block 312. The SCSI driver 332 may execute at an application layer for handling transactions requested by the application 334 with the memory system 110. The UFS driver 330 may execute at a transport layer and manage operation of the data link layer block 314, such as to operate the memory interface 310 at one of a plurality of modes of operations. The modes of operations may include two or more gear settings, such as one or more PWM-GEAR settings and four or more HS-GEAR settings specifying one bitrate from 182 MBps, 364 MBps, 728 MBps, and 1457 MBps.

The memory interface 310 may include one or more lines including a reset RST line, a reference clock REF_CLK line, a data-in DIN line (for data transmissions from the host device 102 to the memory system 110), and a data-out DOUT line (for data transmissions from the memory system 110 to the host device 102). The DIN and DOUT lines may be two separate conductors, or the DIN and DOUT lines may include multiple conductors. In some embodiments, the DIN and DOUT lines may be asymmetric with the DIN line including N conductors and the DOUT line including M conductors, with N>M or M>N.

The UFS driver 330 may generate and decode packets to carry out transactions requested by the application 334. The packets are transmitted over the memory interface 310. The packets may be formatted as UFS Protocol Information Units (UPIUs). In a transaction with the memory system 110, the host device 102 is an initiator and the memory system 110 is a target. The UFS driver 330, based on the type of transaction, may form one of several types of UPIUs for handling SCSI commands, data operations, task management operations, and/or query operations. Each transaction may include one command UPIU, zero or more DATA IN or DATA OUT UPIUs, and a response UPIU. Each UPIU may include a header followed by optional fields depending on the type of UPIU.

One example transaction is a read operation. A read transaction may include the initiator (e.g., host device 102) transmitting a command UPIU for causing the target (e.g., memory system 110) to perform a read operation requested by the application 334. The target provides one or more DATA IN UPIUs in response to the command UPIU, in which the DATA IN UPIUs include the requested data. The read transaction is completed by the target transmitting a Response UPIU.

Another example transaction is a write operation. A write operation may include the initiator (e.g., host device 102) transmitting a command UPIU for causing the target (e.g., memory system 110) to perform a write operation requested by the application 334. The target provides a Ready to Transfer UPIU signaling the initiator to begin transfer of write data. The initiator then transmits one or more DATA OUT UPIUs, which are followed by a Ready to Transfer UPIU signaling the initiator to continue transfer of the write data. The sequence of DATA OUT UPIUs and Ready to Transfer UPIU continues until all write data is provided to the target, after which the target provides a Response UPIU to the initiator.

A further example transaction is a query operation. A query operation may include the initiator (e.g., host device 102) requesting information about the target (e.g., memory system 110). The initiator may transmit a Query Request UPIU to request information such as configuration, enumeration, device descriptor, flags, and/or attributes of the target. Example query operations includes read descriptor, write descriptor, read attribute, write attribute, read flag, set flag, clear flag, and/or toggle flag. Example descriptors include device, configuration, unit, interconnect, string, geometry, power, and/or device health. Example flags include fDeviceInit, fPermanenetWPEn, fPowerOnWPEn, fBackgroundOpsEn, fDeviceLifeSpanModeEn, fPurgeEnable, fRefreshEnable, fPhyResourceRemoval, fBusyRTC, and/or fPermanentlyDisableFwUpdate. Example attributes include bBootLunEn, bCurrentPowerMode, bActiveICCLevel, bOutOfORderDataEn, bBackgroundOpStatus, bPurgeStatus, bMaxDataInSize, bMaxDataOutSize, dDynCapNeeded, bRefClkFreq. Such flags may, for example, be flags identified by the UFS standard.

FIG. 4 is a block diagram illustrating a method for erasing data in a memory device using an update on a mapping table in a host device according to some embodiments of the disclosure. The host device 102 may be electrically coupled to the memory system 110, via one or more buses or lanes. The host device 102 may include a host controller 402 and a memory 106 (e.g., the memory 106 in FIG. 1). The host controller 402 may include the processor 108 and/or the memory controller 104 in FIG. 1 to control the memory 106 and communicate with the memory system 110. The memory 106 of the host device 102 may include a mapping table 404 (e.g., L2P table).

The memory system 110 may include a memory device controller 406, a memory 144 (e.g., the memory in FIG. 1), and/or a memory module 150 (e.g., the memory module 150 in FIG. 1). The memory device controller 406 may include the processor 134 and/or the host interface 132 to control the memory module 150 and the memory 144. The memory 144 of the memory system 110 may include a memory device mapping table 408 (e.g., an L2P table).

The memory device mapping table 408 may include one or more mappings of logical memory block addresses to physical memory block addresses, such as physical memory block addresses of the memory module 150. For example, the memory device mapping table 408 may include logical block address ‘n’ to be mapped to physical block address ‘N.’ Data may be stored in a memory block having physical block address ‘N.’ Thus, the memory device may retrieve the data using the logical block address ‘n’ in the memory device mapping table 408. In some embodiments, the mapping table 404 in the host device 102 may be synchronized with or correspond to the memory device mapping table 408. For example, after the host device 102 updates the mapping table 404, the host device 102 may communicate with the memory device to update the memory device mapping table 408 to be synchronized with the mapping table 404 in the host device 102. A method for erasing data in the memory system 110 using an update on the mapping table 404 in the host device 102 is described in FIG. 4.

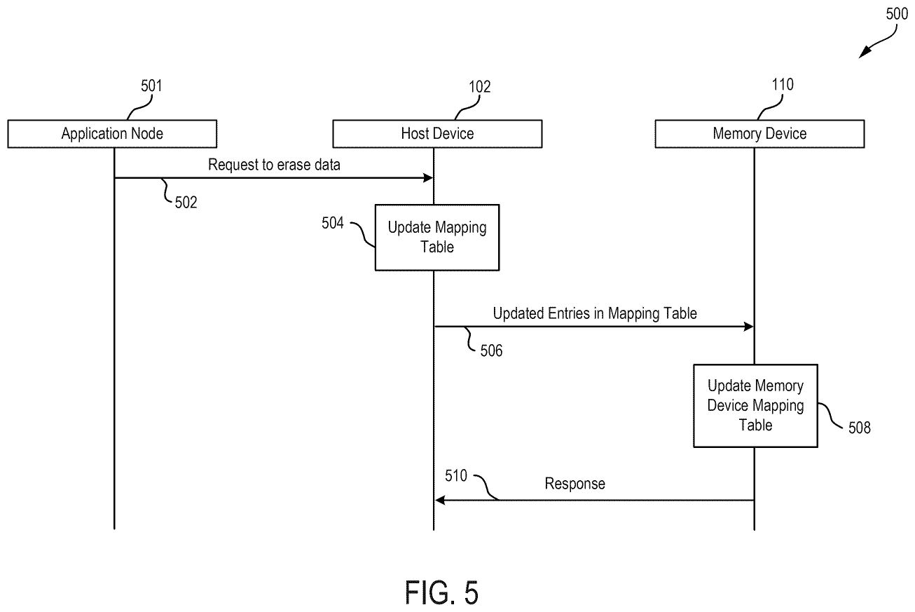

FIG. 5 is a call diagram illustrating a method for erasing data in a memory device using an update on a mapping table in a host device according to some embodiments of the disclosure. At step 502, a host device 102 may receive a request to erase data on a memory device from an application node 501. In some examples, the application node 501 may include the application 334 of the host device 102 in FIG. 3, an application stored in the memory system 110 and executed by the processor 108 in the host device 102 or an application stored in the memory 220 and executed by the processor 230 in the electronic device 200. In other examples, the application node 501 may be executed by a processor separated from the host device 102 or the electronic device 200 but is electrically coupled to the host device 102 (e.g., via a bus, an interface). In further examples, the application node 401 may be a network node, which is communicatively coupled to the host device 102.

The request to erase data may include a request to delete the data, which could include a physical erasing or removal of data or otherwise make the data inaccessible at its current location. For example, the request to erase data may be executed on a logical block address to which the erase is applied by mapping the address to an invalidated physical block address (e.g., a value of zero). After an erase is executed, the application node 501 and/or the host device 102 may not be able to retrieve the erased logical block data. In some examples, the request may include a logical block address for the data. The logical block address may be mapped to a physical block address via a memory device mapping table where the data is stored on the physical block address. The host device may have a mapping table, which is a copy of the memory device mapping table.

At step 504, the host device 102 may update a mapping table in the host device 102 based on the request to erase data. The mapping table (e.g., the mapping table 404 in FIG. 4) stored in the host device 102 may be synchronized with the memory device mapping table (e.g., the memory device mapping table 408 in FIG. 4) stored in the memory system 110. Referring again to FIG. 4, the host device 102 may receive a request to erase data on logical block addresses ‘a’ and ‘c.’ In such examples, the mapping table 404 in the host device 102 originally includes logical block addresses ‘a’ and ‘c’ to be mapped to physical block addresses ‘A’ and ‘C,’ respectively. Because the mapping table 404 is a copy of the memory device mapping table 408 of the memory system 110, the memory device mapping table 408 may include the same information as the mapping table 404 in the host device. The data to be erased is stored in one or memory blocks on physical block addresses ‘A’ and ‘C’ in the memory system 110. In the embodiments, the host device 102 may update the mapping table 404 first when the request to erase data. The host device 102 may update the mapping table 404 to include invalidated logical block addresses corresponding to the data. For example, the host device 102 may set the physical block addresses ‘0’ and ‘0’ to be mapped to logical block addresses ‘a’ and ‘c,’ respectively, in the mapping table 404 in the host device 102. In such examples, the update on the mapping table may include invalidating or unmapping the physical block addresses containing the data in the memory system 110 by setting the physical block addresses mapped to the logical block addresses in the mapping table 404 to zero. The update may be associated with the data to be erased. At block 504, the host device may invalidate the logical block address entries in the mapping table 404 at the host device before the memory device invalidates the logical block address entries in the memory device mapping table 408. After the host device updates the mapping table 404, the mapping table 404 and the memory device mapping table 408 may not be synchronized. Thus, the host device may share the update on the mapping table 404 to the memory system 110 to synchronize the mapping table 404 with the device mapping table 408 of the memory system 110.

At step 506, the host device 102 may transmit the update on the mapping table 404 in the host device to the memory system 110. In some embodiments, the host device 102 may transmit one command to share the invalidated regions with the memory system 110. Referring again to FIG. 4, the host device 102 may transmit the update (e.g., invalidated logical block addresses ‘a’ and ‘c’ with physical block addresses ‘0’ and ‘0,’ respectively) to the mapping table 404 to the memory system 110. For example, the host device may embed the information's as part of Command UPIU or enable the HPB host controller mode upon the request to erase the data.

In some examples, the host device 102 may transmit a command to the memory system 110 (e.g., using the Command UPIU). For example, the command may include a bit and an invalidated logical block address. The bit (e.g., a fifth bit) of the command UPIU may be set to a flag value (e.g., ‘1’). The command may include an invalidated logical block address corresponding to the data. For example, the command may include the Command UPIU, which contains the basic UPIU header and additional information to specify the command. In such examples, the host device 102 may use a reserved bit in the Command UPIU to initiate the erase operation. For example, the reserved bit may be the fifth bit (e.g., the HPU_UPDATE_ALERT bit) of the Command UPIU. The host device 102 may nullify the logical block address based on the request and set the HPB_UPDATE ALERT bit. When the HPB UPDATE ALERT bit is ‘1,’ the host device 102 may indicate which logical block address (e.g., HPB sub-region) is to be inactive or invalidated using a data segment at the memory system 110. The data segment length may be 14 h or any other suitable length. In some examples, HPB sub-regions whose mapping entries in the mapping table may be cached in the host device may be called active sub-regions. The host device may use a HPB read buffer command to retrieve mapping entries of the mapping table from the memory system 110 to the memory in the host device. An active HPB region is a region which includes at least one active HPB sub region. HPB sub-regions having mapping entries in the mapping table are removed from the host device may be called in-active sub-regions. In other examples, the host device 102 may use another bit to initiate the erase operation.

In other examples, the host device 102 may transmit a command to the memory system 110 (e.g., using the HPB write command). For example, the command may include a write command to write the update corresponding to a logical block address in the memory device mapping table 408. The write command may include an invalidated logical block address of the mapping table 404 in the host device. The write command may be configured to set a physical block address in the memory device mapping table 408 to zero. The physical block address may be mapped to the logical block address in the memory device mapping table 408 in the memory system 110.

At step 508, the memory system 110 may update the memory device mapping table 408 based on the updated entries in the mapping table 404. Referring again to FIG. 4, the memory system 110 may receive the update (e.g., invalidated logical block addresses ‘a’ and ‘c’ with physical block addresses ‘0’ and ‘0,’ respectively). Then, the memory system 110 may update the memory device mapping table 408 to have invalidated logical block addresses ‘a’ and ‘c’ with physical block addresses ‘0’ and ‘0,’ respectively.

At step 510, the host device 102 may receive a response from the memory system 110. For example, the host device 102 may receive an indication confirming the memory device mapping table 408 in the memory system 110 has been updated based on the update transmitted from the host device. The indication may include a number, a bit, a letter, a string, a symbol, or any other suitable indication to indicate that the update on the mapping table 404 has been applied to the memory device mapping table 408.

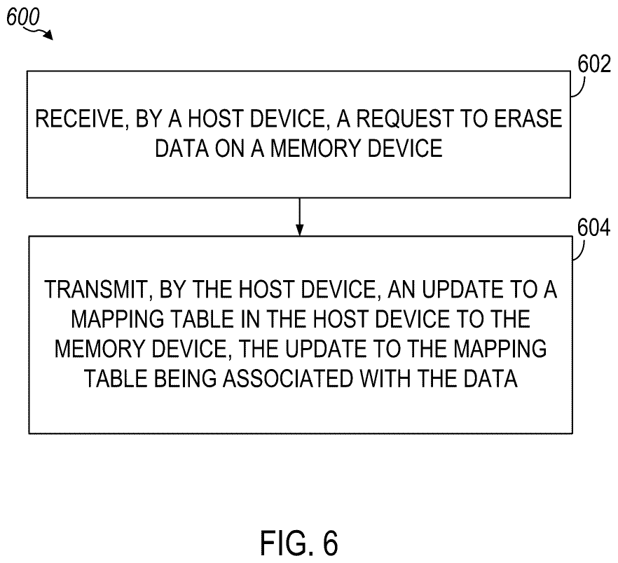

FIG. 6 is a flow chart illustrating a method for erasing data in a memory device using an update on a mapping table in a host device according to some embodiments of the disclosure. Each of the operations described with reference to FIG. 6 may be performed by a memory controller (e.g., one or a combination of the processor 108 coupled to the memory 106 in FIG. 1, the application processor 230 coupled to the memory 220, the controller 402 in FIG. 4, and/or the host device 102 in FIG. 5).

At block 602, the memory controller receives a request to erase data on the memory device. In some examples, block 602 may correspond to step 502 in FIG. 5. The memory device may correspond to the memory system 110 in FIG. 5.

At block 604, the memory controller transmits an update on a mapping table in the host device, the update on the mapping table being associated with the data. In some examples, the update comprises an invalidated logical block address of the mapping table corresponding to the data. In some examples, the update on the mapping table may correspond to block 504 in FIG. 5. In some examples, the memory controller may further transmit a command to the memory device, wherein a fifth bit of the command is set to one. Transmitting the command may include transmitting an invalidated logical block address corresponding to the data as part of the command. In some examples, transmitting the update may correspond to step 506 in FIG. 5. The command associated with the fifth bit at block 605 is described in connection with step 506 in FIG. 5.

In other examples, the memory controller may further transmit a command to the memory device, wherein the command may include a write command to write the update corresponding to a logical block address in a memory device mapping table of the memory device, the update comprising an invalidated logical block address of the mapping table. For example, the write command is configured to set a physical block address in the memory device mapping table to zero, the physical block address being mapped to the logical block address in the memory device mapping table. The command including the write command at block 605 is described in connection with step 506 in FIG. 5.

Additionally or alternatively, the memory controller may receive an indication confirming a memory device mapping table in the memory device has been updated based on the update transmitted from the host device. In some examples, the receiving of the indication confirming the update may correspond to step 510 in FIG. 5.

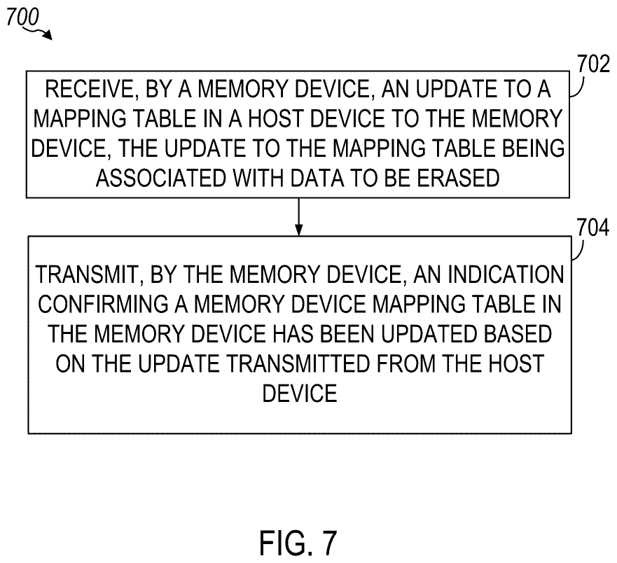

FIG. 7 is a flow chart illustrating a method for erasing data in a memory device using an update on a mapping table in a host device according to some embodiments of the disclosure. Each of the operations described with reference to FIG. 7 may be performed by a memory controller (e.g., one or a combination of the processor 134 coupled to the memory 144 in FIG. 1, the storage system 250, the controller 406 in FIG. 4, and/or the memory system 110 in FIG. 5).

At block 702, the memory controller may receive an update on a mapping table in the host device, the update on the mapping table being associated with the data. In some examples, the receiving of the update in block 702 may correspond to step 506 in FIG. 5. For example, the update may include an invalidated logical block address of the mapping table corresponding to the data. The update may correspond to block 504 and/or step 506 in FIG. 5. In some examples, the memory controller may further receive a command from the host device, wherein a fifth bit of the command is set to one. In some examples, receiving the command may include receiving an invalidated logical block address corresponding to the data as part of the command. In some examples, the command associated with the fifth bit at block 605 is described in connection with step 506 in FIG. 5.

In other examples, the memory controller may further receive a command to the memory device. The command may include a write command to write the update corresponding to a logical block address in a memory device mapping table of the memory device. The update may include an invalidated logical block address of the mapping table. The command including the write command at block 605 is described in connection with step 506 in FIG. 5.

In some examples, the memory controller may set a physical block address in the memory device mapping table to zero based on the write command, the physical block address being mapped to the logical block address in the memory device mapping table. In some examples, the setting of the physical block address in the memory device mapping table may correspond to block 508 in FIG. 5.

At block 704, the memory controller transmits an indication confirming a memory device mapping table in the memory device has been updated based on the update transmitted from the host device. In some examples, the transmitting of the indication confirming the update may correspond to step 510 in FIG. 5.

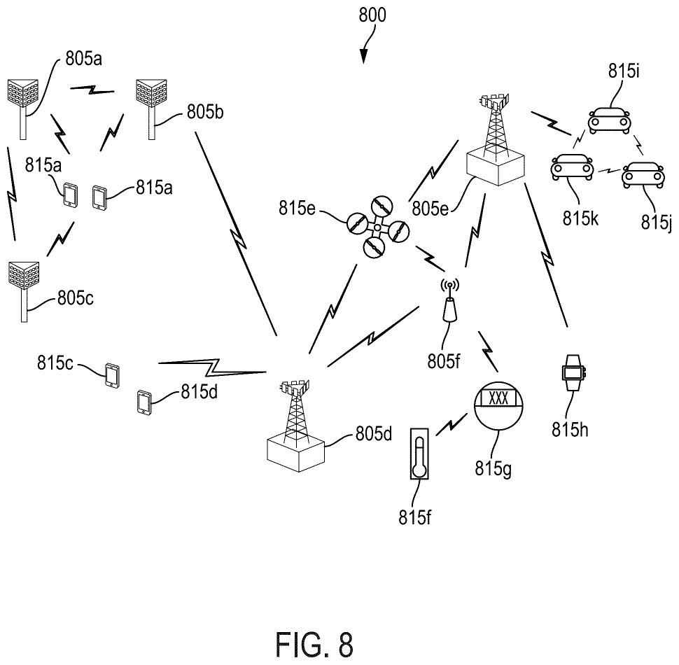

Operations of method 500, method 600, or method 700 may be performed by a UE, such as a UE described with reference to FIG. 8. For example, example operations (also referred to as “blocks”) of method 500 or method 600 may enable UE 815 to support greater user data confidentiality. FIG. 8 is a block diagram illustrating details of an example wireless communication system according to one or more aspects. The wireless communication system may include wireless network 800. Wireless network 800 may, for example, include a 5G wireless network. As appreciated by those skilled in the art, components appearing in FIG. 8 are likely to have related counterparts in other network arrangements including, for example, cellular-style network arrangements and non-cellular-style-network arrangements (e.g., device to device or peer to peer or ad hoc network arrangements, etc.).

Wireless network 800 illustrated in FIG. 8 includes a number of base stations 805 and other network entities. A base station may be a station that communicates with the UEs and may also be referred to as an evolved node B (eNB), a next generation eNB (gNB), an access point, and the like. Each base station 805 may provide communication coverage for a particular geographic area. In 3GPP, the term “cell” may refer to this particular geographic coverage area of a base station or a base station subsystem serving the coverage area, depending on the context in which the term is used. In implementations of wireless network 800 herein, base stations 805 may be associated with a same operator or different operators (e.g., wireless network 800 may include a plurality of operator wireless networks). Additionally, in implementations of wireless network 800 herein, base station 805 may provide wireless communications using one or more of the same frequencies (e.g., one or more frequency bands in licensed spectrum, unlicensed spectrum, or a combination thereof) as a neighboring cell. In some examples, an individual base station 805 or UE 815 may be operated by more than one network operating entity. In some other examples, each base station 805 and UE 815 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 8, base stations 805d and 805e are regular macro base stations, while base stations 805a-805c are macro base stations enabled with one of 3 dimension (3D), full dimension (FD), or massive MIMO. Base stations 805a-805c take advantage of their higher dimension MIMO capabilities to exploit 3D beamforming in both elevation and azimuth beamforming to increase coverage and capacity. Base station 805f is a small cell base station which may be a home node or portable access point. A base station may support one or multiple (e.g., two, three, four, and the like) cells.

Wireless network 800 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 815 are dispersed throughout the wireless network 800, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 815, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a flying device, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 815a-815d of the implementation illustrated in FIG. 8 are examples of mobile smart phone-type devices accessing wireless network 800. A UE may also be a machine specifically configured for connected communication, including machine type communication (MTC), enhanced MTC (eMTC), narrowband IoT (NB-IoT) and the like. UEs 815e-815k illustrated in FIG. 8 are examples of various machines configured for communication that access wireless network 800.

A mobile apparatus, such as UEs 815, may be able to communicate with any type of the base stations, whether macro base stations, pico base stations, femto base stations, relays, and the like. In FIG. 8, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 800 may occur using wired or wireless communication links.

In operation at wireless network 800, base stations 805a-805c serve UEs 815a and 815b using 3D beamforming and coordinated spatial techniques, such as coordinated multipoint (COMP) or multi-connectivity. Macro base station 805d performs backhaul communications with base stations 805a-805c, as well as small cell, base station 805f. Macro base station 805d also transmits multicast services which are subscribed to and received by UEs 815c and 815d. Such multicast services may include mobile television or stream video, or may include other services for providing community information, such as weather emergencies or alerts, such as Amber alerts or gray alerts.

Wireless network 800 of implementations supports mission critical communications with ultra-reliable and redundant links for mission critical devices, such UE 815e, which is an aeronautical vehicle. Redundant communication links with UE 815e include from macro base stations 805d and 805e, as well as small cell base station 805f. Other machine type devices, such as UE 815f (thermometer), UE 815g (smart meter), and UE 815h (wearable device) may communicate through wireless network 800 either directly with base stations, such as small cell base station 805f, and macro base station 805e, or in multi-hop configurations by communicating with another user device which relays its information to the network, such as UE 815f communicating temperature measurement information to the smart meter, UE 815g, which is then reported to the network through small cell base station 805f. Wireless network 800 may also provide additional network efficiency through dynamic, low-latency TDD communications or low-latency FDD communications, such as in a vehicle-to-vehicle (V2V) mesh network between UEs 815i-815k communicating with macro base station 805e.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANs.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In one or more aspects, techniques for supporting data storage and/or data transmission, may include additional aspects, such as any single aspect or any combination of aspects described below or in connection with one or more other processes or devices described elsewhere herein. In a first aspect, an electronic device, such as a UE, may be an apparatus operating as a host device that includes a memory controller configured to couple to an interface to a memory system, in which the memory system may be integrated with the host device or externally coupled to the host device. The memory system may include a memory controller coupled to a memory system through a first channel and configured to access data stored in the memory system through the first channel and coupled to a host device through a first interface and configured to communicate with the host device over the first interface. The operations may be executed as part of an initialization operation, a read operation or a write operation.

In a first aspect, the memory controller of the host device may be configured to perform operations including receiving, by the memory controller of the host device, a request to erase data on the memory device; and transmitting, by the memory controller of the host device, an update on a mapping table in the host device, the update on the mapping table being associated with the data.

In a second aspect, in combination with the first aspect, the update comprises an invalidated logical block address of the mapping table corresponding to the data.

In a third aspect, in combination with one or more of the first aspect or the second aspect, the memory controller is configured to perform the operations further including transmitting a command to the memory device as part of a command UFS Protocol Information Unit (UPIU), wherein a fifth bit of the command UPIU is set to one.

In a fourth aspect, in combination with one or more of the first aspect through the third aspect, transmitting the command comprises transmitting the update on the mapping table as an invalidated logical block address corresponding to the data as part of the command UPIU.

In a fifth aspect, in combination with one or more of the first aspect through the fourth aspect, the memory controller is configured to perform the operations further including transmitting a command to the memory device, wherein the command comprises a write command to write the update corresponding to a logical block address in a memory device mapping table of the memory device, the update comprising an invalidated logical block address of the mapping table corresponding to the data, and wherein the command comprises a HPB write command UFS Protocol Information Unit (UPIU).

In a sixth aspect, in combination with one or more of the first aspect through the fifth aspect, the write command is configured to set a physical block address in the memory device mapping table to zero, the physical block address being mapped to the logical block address in the memory device mapping table.

In a seventh aspect, in combination with one or more of the first aspect through the sixth aspect, the memory controller is configured to perform the operations further including receiving an indication confirming a memory device mapping table in the memory device has been updated based on the update transmitted from the host device.

In an eighth aspect, in combination with one or more of the first aspect through the seventh aspect, the memory controller couples the host device to a memory system comprising a flash memory device configured as a universal flash storage (UFS) device.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4A-E, 5, or 6 may be combined with one or more blocks (or operations) described with reference to another of the figures. For example, one or more blocks (or operations) of FIG. 1 may be combined with one or more blocks (or operations) of FIG. 3. As another example, one or more blocks associated with FIG. 1 may be combined with one or more blocks (or operations) associated with FIGS. 4A-E, 5, or 6. Additionally, or alternatively, one or more operations described above with reference to FIGS. 1-3 may be combined with one or more operations described with reference to FIGS. 4-6.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus, comprising:
a memory controller of a host device configured to couple the host device to a memory device through a first interface, the memory controller configured to perform operations including:
receiving, by the memory controller of the host device, a request to erase data on the memory device; and
transmitting, by the memory controller of the host device, a command to the memory device as part of a command UFS Protocol Information Unit (UPIU), the command UPIU comprising an invalidated logical block address of a mapping table in the host device corresponding to the data, wherein the command to the memory device is a command to update a corresponding logical block address in a memory device mapping table in the memory device.

2. (canceled)

3. The apparatus of claim 1,
wherein a fifth bit of the command UPIU is set to one.

4. (canceled)

5. The apparatus of claim 1,
wherein the command UPIU comprises a HPB write command UPIU to write an update to the corresponding logical block address in the memory device mapping table in the memory device, the update comprising the invalidated logical block address of the mapping table corresponding to the data.

6. The apparatus of claim 5, wherein the HPB write command UPIU is configured to set a physical block address in the memory device mapping table to zero, the physical block address being mapped to the corresponding logical block address in the memory device mapping table.

7. The apparatus of claim 1, wherein the memory controller is configured to perform the operations further including:
receiving an indication confirming the memory device mapping table in the memory device has been updated based on the command transmitted from the host device.

8. The apparatus of claim 1, wherein the memory controller couples the host device to a memory system comprising a flash memory device configured as a universal flash storage (UFS) device.

9. A method comprising:
receiving, by a host device, a request to erase data on a memory device; and
transmitting, by the host device, a command to the memory device as part of a command UFS Protocol Information Unit (UPIU), the command UPIU comprising an invalidated logical block address of a mapping table in the host device corresponding to the data, wherein the command to the memory device is a command to update a corresponding logical block address in a memory device mapping table in the memory device.

10. (canceled)

11. The method of claim 9,
wherein a fifth bit of the command UPIU is set to one.

12. (canceled)

13. The method of claim 9,
wherein the command UPIU comprises a HPB write command UPIU to write an update to the corresponding logical block address in the memory device mapping table in the memory device, the update comprising the invalidated logical block address of the mapping table.

14. The method of claim 13, wherein the HPB write command is configured to set a physical block address in the memory device mapping table to zero, the physical block address being mapped to the corresponding logical block address in the memory device mapping table.

15. The method of claim 9, further comprising:
receiving an indication confirming the memory device mapping table in the memory device has been updated based on the command transmitted from the host device.

16. An apparatus, comprising:
a memory controller of a memory device:
coupled to a memory module through a first channel and configured to access data stored in the memory module through the first channel; and
coupled to a host device through a first interface and configured to communicate with the host device over the first interface,
the memory controller configured to perform operations comprising:
receiving, by the memory controller of the memory device, a command from the host device as part of a command UFS Protocol Information Unit (UPIU), the command UPIU comprising an invalidated logical block address of a mapping table in the host device corresponding to data to be erased, wherein the command from the host device is a command to update a corresponding logical block address in a memory device mapping table in the memory device; and
transmitting, by the memory controller of the memory device, an indication confirming the memory device mapping table in the memory device has been updated based on the command transmitted from the host device.

17. The apparatus of claim 16,
wherein a fifth bit of the command UPIU is set to one.

18. (canceled)

19. The apparatus of claim 16,
wherein the command UPIU comprises a HPB write command UPIU to write an update to the corresponding logical block address in the memory device mapping table in the memory device, the update comprising the invalidated logical block address of the mapping table.

20. The apparatus of claim 19, wherein the memory controller is configured to perform the operations further including:
setting a physical block address in the memory device mapping table to zero based on the HPB write command, the physical block address being mapped to the corresponding logical block address in the memory device mapping table.
